(19) United States
(12) Patent Application Publication
(10) Pub. No.: US 2009/0147905 A1
(43) Pub. Date: Jun. 11, 2009

(54) ULTRASONIC TREATMENT CHAMBER FOR INITIATING THERMONUCLEAR FUSION

(75) Inventors: Robert Allen Janssen, Alpharetta, GA (US); John Glen Ahles, Neenah, WI (US); Thomas David Ehlert, Neenah, WI (US); John Gavin MacDonald, Decatur, GA (US); Earl C. McCraw, JR., Duluth, GA (US); Patrick Sean McNichols, Hortonville, WI (US); Paul Warren Rasmussen, Neenah, WI (US); Steve Roffers, Neenah, WI (US)

Correspondence Address: Christopher M. Goff (27839);ARMSTRONG TEASDALE LLP, ONE METROPOLITAN SQUARE, SUITE 2600, ST. LOUIS, MO, 63102, US

(73) Assignee: KIMBERLY-CLARK WORLDWIDE, INC., Neenah, WI (US)

(21) Appl. No.: 11/950,943

(22) Filed: Dec. 5, 2007

(51) Int. Cl. G21B 1/11

(52) U.S. Cl. 376/150

(57) ABSTRACT

A thermonuclear fusion system having a treatment chamber in which gas isotopes are fused to initiate a thermonuclear fusion reaction is disclosed. Specifically, the treatment chamber has an elongate housing through which liquid and gas isotopes flow longitudinally from an inlet port to an outlet port thereof. An elongate ultrasonic waveguide assembly extends within the housing and is operable at a predetermined ultrasonic frequency and a predetermined electrode potential to ultrasonically enhance the concentration of dissolved hydrogen gas isotopes within the housing or energize and electrolyze the liquid and gas isotopes within the housing. An elongate ultrasonic horn of the waveguide assembly is disposed at least in part intermediate the inlet and outlet ports, and has a plurality of discrete agitating members in contact with and extending transversely outward from the horn intermediate the inlet and outlet ports in longitudinally spaced relationship with each other. The horn and agitating members are constructed and arranged for dynamic motion of the agitating members relative to the horn at the predetermined frequency and to operate in an ultrasonic cavitation mode of the agitating members corresponding to the predetermined frequency and the liquid and gas isotopes being treated in the chamber.

### FIELD OF DISCLOSURE

The present disclosure relates generally to systems for fusing hydrogen isotopes together for the release of large amounts of energy for both industrial and residential use. More particularly a thermonuclear fusion system is disclosed for ultrasonically treating and electrolyzing a flowing carrier liquid and hydrogen gas isotopes to generate a sufficient temperature and pressure to initiate thermonuclear fusion of hydrogen gas isotopes.

### BACKGROUND OF DISCLOSURE

Growing energy requirements around the world will place a strain on our current energy sources. Affordable and plentiful energy is essential towards maintaining healthy industrial societies, as well as raising the standard of living within developing countries. Fusion could provide the energy to meet these requirements, having potential benefits including: a very abundant supply of energy world-wide; an environmentally cleaner source of energy (no air pollution and little if any high level nuclear waste), as well as an alternative to fossil fuels and fission reactors; no creation of material for weapons; research and development in fusion could create technological spin-offs (superconducting magnets, high-power lasers, high speed computing, etc.); help economic growth as a reliable electricity supply; and no chance of runaway reactions leading to accidents.

Generally, fusion is the Sun's energy source, joining light atomic nuclei to form heavier atoms like helium. Here on Earth, future fusion plants will imitate the Sun, fusing deuterium and tritium atoms at temperatures over 5,000 degrees K, releasing energy for a variety of uses, including electricity. The fuel for this fusion is found in water, and can therefore provide energy for the world for billions of years.

To cause fusion here on Earth, the atoms, generally hydrogen atoms, to be fused must be in the form of a plasma. To achieve this new state of matter, a gas (i.e., hydrogen gas) is heated, causing the atoms to move very rapidly. At a high enough temperature, the electrons become separated from the nuclei, thus creating a cloud of charged particles, or ions. This cloud of equal amounts of positively charged nuclei and negatively charged electrons is called a plasma. The Sun, stars, lightning, and the gas in neon signs are all plasmas. Even higher temperatures are needed to cause the nuclei to collide and fuse. Such a condition where the thermal energy of nuclei is high enough to fuse despite their repulsion is called thermonuclear.

One previous attempt to create thermonuclear fusion included subjecting liquid acetone to an acoustic pressure field that oscillated in resonance with the liquid sample and its container. The nucleation of vapor bubbles was initiated with fast neutrons from an isotopic source (Pu—Be) or from a pulsed neutron generator that produces 14-MeV neutrons on demand at a predefined phase of the acoustic pressure field. (see Taleyarkhan, et al., “Evidence for Nuclear Emissions During Acoustic Cavitation,” Science, (Mar. 8, 2002), Vol. 295, pp. 1868-1873). One problem with the above attempt is that it was not reproducible. Specifically, while many other physicists tried recreating the reaction, all found that the acoustic reactor put out less energy than it required and, as such, the method was impractical for generating power.

Based on the foregoing, there is a need in the art for a thermonuclear fusion system that provides ultrasonic energy to enhance a fusion reaction that will release a greater amount of energy than is required to run the system. Furthermore, it would be advantageous if the system could be configured to enhance the cavitation mechanism of the ultrasonics, thereby increasing the probability of having a successful fusion reaction.

### SUMMARY OF DISCLOSURE

In one aspect, a thermonuclear fusion system for fusing hydrogen isotopes generally comprises a treatment chamber comprising an elongate housing having longitudinally opposite ends and an interior space. The housing is generally closed at at least one of its longitudinal ends and has at least one inlet port for receiving a carrier liquid and hydrogen gas isotopes into the interior space of the housing and at least one outlet port through which treated liquid is exhausted from the housing following ultrasonic treatment of the carrier liquid and hydrogen gas isotopes, the ultrasonic treatment of which initiates the fusing of the hydrogen gas isotopes within the carrier liquid to form the treated liquid. The outlet port is spaced longitudinally from the inlet port such that liquid flows longitudinally within the interior space of the housing from the inlet port to the outlet port. In one embodiment, the housing includes two separate ports for receiving the carrier liquid and a third port for receiving hydrogen gas isotopes. At least one elongate ultrasonic waveguide assembly extends longitudinally within the interior space of the housing and is operable at a predetermined ultrasonic frequency to ultrasonically energize liquid flowing within the housing.

The waveguide assembly comprises an elongate ultrasonic horn disposed at least in part intermediate the inlet port and the outlet port of the housing and has an outer surface located for contact with the carrier liquid and hydrogen gas isotopes flowing within the housing from the inlet port to the outlet port. A plurality of discrete agitating members are in contact with and extend transversely outward from the outer surface of the horn intermediate the inlet port and the outlet port in longitudinally spaced relationship with each other. The agitating members and the horn are constructed and arranged for dynamic motion of the agitating members relative to the horn upon ultrasonic vibration of the horn at the predetermined frequency and to operate in an ultrasonic cavitation mode of the agitating members corresponding to the predetermined frequency and the carrier liquid being treated in the chamber. An electrical current source is further in electrical contact with the outer surface of the horn and a sidewall of the housing, thereby producing an electrode potential within the interior space of the housing. In one particularly preferred embodiment, the treatment chamber further includes at least a first insulating member and a second insulating member electrically insulating the housing from the waveguide assembly.

In one particularly preferred aspect, the treatment chamber for fusing hydrogen isotopes comprises a first and second elongate ultrasonic waveguide assembly. Generally, the thermonuclear fusion system comprises a treatment chamber comprising an elongate housing having longitudinally opposite ends, an interior space, at least a first inlet port for receiving carrier liquid and gas isotopes into the interior space of the housing and at least one outlet port through which treated liquid is exhausted from the housing following ultrasonic treatment of the carrier liquid and hydrogen gas isotopes. The outlet port is spaced longitudinally from the first inlet port such that liquid flows longitudinally within the interior space of the housing from the inlet port to the outlet port. A first elongate ultrasonic waveguide assembly extends longitudinally within the interior space of the housing and is operable at a first predetermined ultrasonic frequency to ultrasonically energize the carrier liquid and hydrogen gas isotopes flowing within the housing. A second elongate ultrasonic waveguide assembly extends longitudinally within the interior space of the housing and is oriented in parallel to the first elongate ultrasonic waveguide assembly. The second waveguide assembly is operable at a second predetermined ultrasonic frequency to ultrasonically energize the carrier liquid and hydrogen gas isotopes flowing within the housing.

The first waveguide assembly comprises a first elongate ultrasonic horn disposed at least in part intermediate the first inlet port and the outlet port of the housing and having an outer surface located for contact with carrier liquid and hydrogen gas isotopes flowing within the housing from the inlet port to the outlet port. The second waveguide assembly comprises a second elongate ultrasonic horn disposed at least in part intermediate the first inlet port and the outlet port of the housing and having an outer surface located for contact with carrier liquid and hydrogen gas isotopes flowing within the housing from the first inlet port to the outlet port. The first horn and second horn are each independently constructed for both longitudinal displacement and radial displacement in response to ultrasonic vibration of the first horn and second horn at the first predetermined ultrasonic frequency and the second predetermined ultrasonic frequency, respectively. A plurality of agitating members is in contact with and extends transversely outward from the outer surface of the first horn intermediate the first and third inlet ports and the outlet port. A separate plurality of agitating members is in contact with and extends transversely outward from the outer surface of the second horn intermediate the second inlet port and the outlet port. The agitating members of both the first horn and second horn independently comprise a transverse component extending generally transversely outward from the outer surface of the first horn and second horn. Furthermore, each agitating member of the plurality of agitating members extending outward from the first horn are in longitudinally spaced relationship with each other, and each agitating member of the plurality of agitating members extending outward from the second horn are in longitudinally spaced relationship with each other. An electrical current source is further in electrical contact with the outer surface of the first horn and the outer surface with the second horn, thereby producing an electrode potential within the interior space of the housing. In one particularly preferred embodiment, the treatment chamber further includes at least a first insulating member and a second insulating member electrically insulating the housing from the first waveguide assembly and, additionally, at least a third insulating member and a fourth insulating member electrically insulating the housing from the second waveguide assembly.

The present invention if further directed to a method of generating hydrogen gas isotopes to be fused in the thermonuclear treatment system. The method comprises delivering a heavy water to the treatment chamber of the treatment system. The heavy water is selected from the group consisting of deuterated heavy water and tritiated heavy water. Once in the treatment chamber, the heavy water is electrolyzed to generated hydrogen gas isotopes.

Other features of the present disclosure will be in part apparent and in part pointed out hereinafter.

### BRIEF DESCRIPTION OF THE DRAWINGS

FIG. 1 is a schematic of a thermonuclear fusion system according to a first embodiment of the present disclosure for fusing hydrogen isotopes.

FIG. 2 is a schematic of a thermonuclear fusion system according to a second embodiment of the present disclosure for fusing hydrogen isotopes.

FIG. 3 is a schematic of a thermonuclear fusion system according to a third embodiment of the present disclosure for fusing hydrogen isotopes.

Corresponding reference characters indicate corresponding parts throughout the drawings.

### DETAILED DESCRIPTION

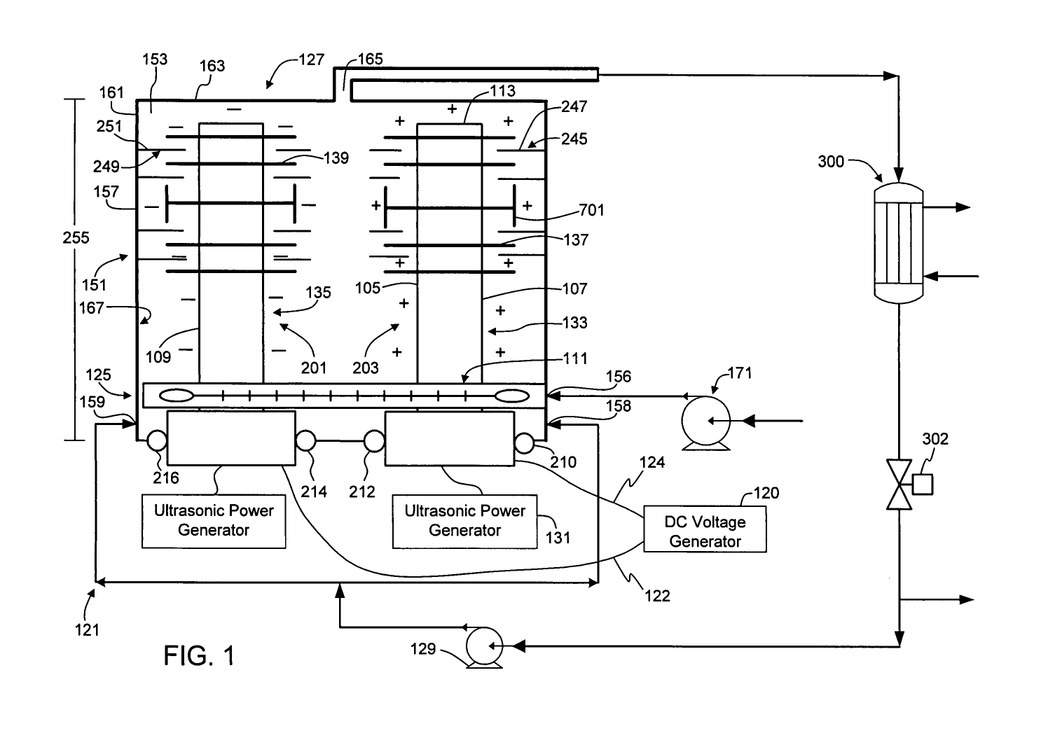

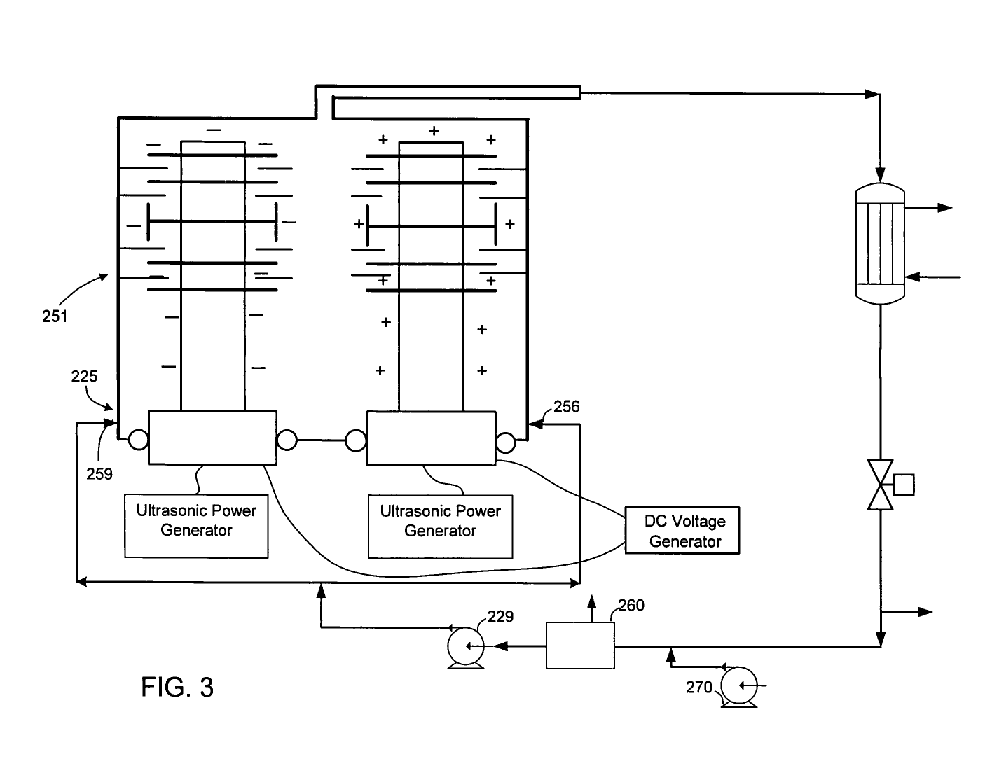

With particular reference now to FIG. 1, in one embodiment, a thermonuclear fusion system for thermonuclear fusing of hydrogen gas isotopes generally comprises a treatment chamber, generally indicated at 121, that is operable to ultrasonically treat a carrier liquid and hydrogen gas isotopes, thereby creating a cavitation mode that allows for an increase in both temperature and pressure within the housing 151 of the chamber 121 to initiate a thermonuclear fusion reaction. Furthermore, the treatment chamber 151 contains ultrasonic horns 133 and 135 that independently act as electrodes (i.e., an anode and cathode) to attract the respective hydrogen gas isotopes towards the horns' outer surfaces 107 and 109, respectively, through the dipole moment on the gas isotopes, as described more fully below. Under such conditions, there is an increased concentration of hydrogen gas isotopes around the respective electrodes (i.e., outer surfaces of the horns), further initiating thermonuclear fusion reactions. In one embodiment, as depicted in FIG. 3, the treatment chamber 451 can further create hydrogen gas isotopes for fusion through the electrolysis of deuterated and/or tritiated heavy water as described more fully below.

It is generally believed that under the increased concentration of the hydrogen gas isotopes around the outer surfaces of the horns, a thermonuclear fusion reaction can be initiated, specifically under the cavitation mode that is created by the waveguide assemblies as described more fully below. The temperature and pressure conditions generated within the housing of the treatment chamber, specifically generated by the cavitation mechanism created by the waveguide assemblies, will help initiate thermonuclear fusion of the hydrogen gas isotopes. More specifically, as ultrasonic energy is created by the waveguide assemblies, increased cavitation of the carrier liquid occurs, creating microbubbles. As these microbubbles then collapse, the pressure and temperature within the carrier liquid are both increased. These increased pressures will generally increase the concentration of the dissolved hydrogen gas isotopes in the carrier liquid, and with a greater concentration of dissolved hydrogen gas isotopes in the carrier liquid, it is believed that the greater the probability of two hydrogen gas isotopes fusing will be. Specifically, by increasing the gas isotope concentration in the carrier liquid, a greater probability is thought to be created that during a cavitation bubble collapse, the bubble will contain the gas isotope and thereby generate a thermonuclear fusion reaction. Specifically, pressures greater than 3,700 atmospheres can be generated depending upon the carrier liquid used. Furthermore, temperatures as high as 1,000,000° K or more may be created during the cavitation mode created within the treatment chamber. The increased temperature resulting from the collapse of the cavitation bubble will also facilitate the thermonuclear fusion of the hydrogen gas isotopes.

Furthermore, processing carrier liquids, hydrogen gas isotopes, and other reactors within the treatment chamber having the specific ultrasonic horn configuration as described herein, and furthermore, through electrochemical processing can provide various other advantages, including, significantly less energy is required; it is a less hazardous process; process is more simplified as compared to a multi-step chemical reaction; and cheaper and more readily available starting materials can be used.

The term “liquid” as used herein is intended to refer to a single component liquid, a solution comprised of two or more components in which at least one of the components is a liquid such as a liquid-liquid mixture, a liquid-gas mixture or a liquid in which particulate matter is entrained, or other viscous fluids.

The treatment fusion system 121 is illustrated schematically in FIG. 1 and further described herein with reference to use of the treatment chamber in a fusion system to fuse two or more hydrogen gas isotopes in a carrier liquid to create a treated liquid. The treated liquid can subsequently provide thermal energy for powering numerous sources, such as electric generators and the like. For example, in one embodiment, the thermal energy can be extracted from the treated liquid in the form of steam to power steam turbines for electricity generation, operate machinery through mechanical means by rotating shafts or pistons through the generated steam.

In one particularly preferred embodiment, as illustrated in FIG. 1, the treatment chamber 151 is generally elongate and has a general inlet end 125 (a lower end in the orientation of the illustrated embodiment) and a general outlet end 127 (an upper end in the orientation of the illustrated embodiment). The treatment chamber 151 is configured such that fluid (e.g., carrier liquid) enters the treatment chamber 151 generally at the inlet end 125 thereof, flows generally longitudinally within the chamber (e.g., upward in the orientation of illustrated embodiment) and exits the chamber generally at the outlet end 127 of the chamber.

The terms “upper” and “lower” are used herein in accordance with the vertical orientation of the treatment chamber 151 illustrated in the various drawings and are not intended to describe a necessary orientation of the chamber in use. That is, while the chamber 151 is most suitably oriented vertically, with the outlet end 127 of the chamber above the inlet end 125 as illustrated in the drawing, it should be understood that the chamber may be oriented with the inlet end above the outlet end, or it may be oriented other than in a vertical orientation and remain within the scope of this disclosure.

The terms “axial” and “longitudinal” refer directionally herein to the vertical direction of the chamber 151 (e.g., end-to-end such as the vertical direction in the illustrated embodiment of FIG. 1). The terms “transverse”, “lateral” and “radial” refer herein to a direction normal to the axial (e.g., longitudinal) direction. The terms “inner” and “outer” are also used in reference to a direction transverse to the axial direction of the treatment chamber 151, with the term “inner” referring to a direction toward the interior of the chamber and the term “outer” referring to a direction toward the exterior of the chamber.

The inlet end 125 of the treatment chamber 151 is in fluid communication with a suitable delivery system, generally indicated at 129, that is operable to direct one or more liquid solutions to, and more suitably through, the chamber 151. Although not illustrated, it should be understood by one skilled in the art that the delivery system 129 may comprise one or more pumps operable to pump the respective solutions from a corresponding source thereof to the inlet end 125 of the chamber 151 via suitable conduits (not shown).

It is understood that the delivery system 129 may be configured to deliver more than one liquid solution, such as when mixing liquid solutions, to the treatment chamber 151 without departing from the scope of this disclosure. It is also contemplated that delivery systems other than that illustrated in FIG. 1 and described herein may be used to deliver one or more solutions to the inlet end 125 of the treatment chamber 151 without departing from the scope of this disclosure. It should be understood that more than one liquid solution can refer to two streams of the same liquid or different liquids being delivered to the inlet end of the treatment chamber without departing from the scope of the present disclosure.

Furthermore, the inlet end 125 may be in fluid communication with a gas sparge, generally indicated at 171, designed to force gas into the interior of the housing. The gas sparge 171 facilitates the flow of isotopes (e.g., hydrogen gas isotopes) transversely inward toward the horn to thereby facilitate ultrasonic energization (i.e., agitation), which can mix the isotopes with the carrier liquid to allow for collision of the isotopes in the carrier liquid to initiate a fusion reaction. In the present treatment chamber, hydrogen gas isotopes are forced through a porous media so as to create small air bubbles. Desirably, the gas sparge used in the treatment chamber has a gas diffuser porosity rated from medium to fine and a gas flow rate of from about 0.001 liters per minute to about 10 liters per minute and, more suitably, from about 0.01 liters per minute to about 5 liters per minute. Furthermore, the gas sparge forces the hydrogen gas isotopes into the interior of the housing at a gas pressure of from about 0.2 psi gauge pressure to about 100 psi gauge pressure and, more suitably, from about 10 psi gauge pressure to about 50 psi gauge pressure, depending upon the desired gas flow rate and back pressure of the fusion system.

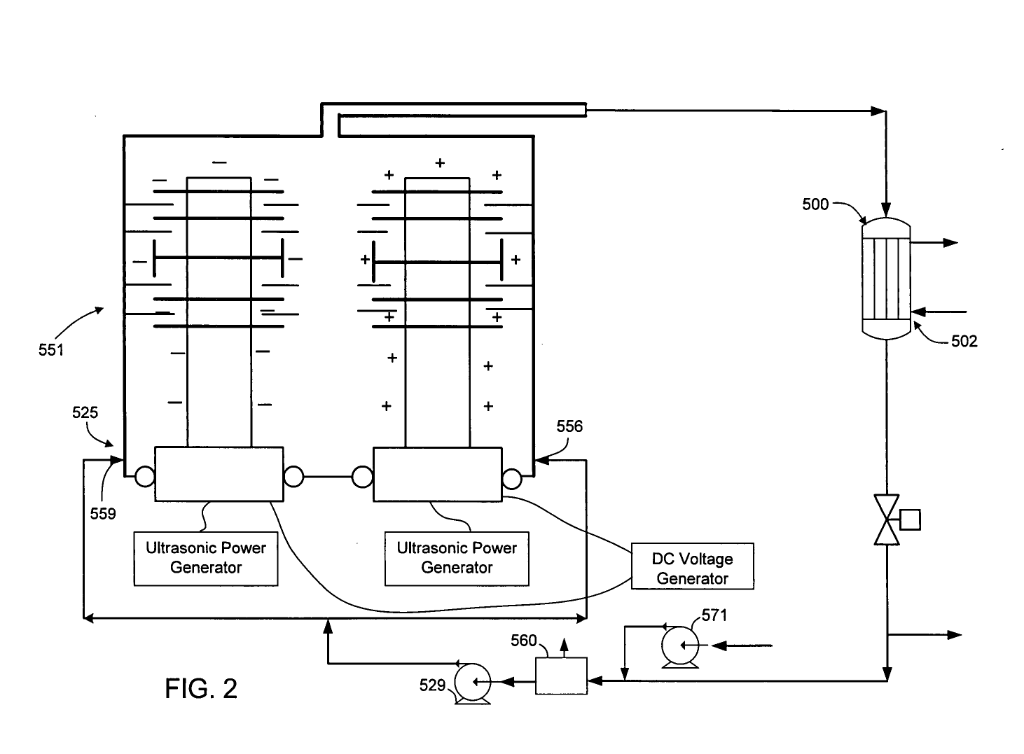

As described more fully below, in an alternative embodiment as depicted in FIG. 2, the gas sparge 571 does not directly force gas isotopes into the inlet end 525 of the treatment chamber 551. Instead, the gas sparge 571 forces gas into a degasser 560, described more fully below, and then carrier liquid (with excess gas removed) is delivered to the delivery system 529, and then the delivery system 529 delivers the carrier liquid to the inlet end 525 of the treatment chamber. Specifically, in FIG. 2, the delivery system 529 delivers the carrier liquid to the interior of the chamber 551 through a first inlet 556 and a second inlet 559.

In yet another alternative embodiment, as shown in FIG. 3, the gas sparge as described above is removed from the system and hydrogen gas isotopes are generated using heavy water. Specifically, in one embodiment, deuterated and/or tritiated heavy water including deuterium and/or tritium hydrogen gas isotopes is pumped from a heavy water pump 270 to the degasser 260 (described in FIG. 2 above). Once the excess gas is removed from the heavy water, the carrier liquid is delivered to the delivery system 229 and subsequently delivered to the inlet end 225 of the treatment chamber 251. Specifically, in FIG. 3, the delivery system 229 delivers the carrier liquid to the interior of the chamber 251 through a first inlet 256 and a second inlet 259. Once in the treatment chamber, the carrier liquid is electrolyzed to generated dissolved hydrogen gas isotopes to be fused in the chamber.

Now referring back to FIG. 1, the treatment chamber 151 comprises a housing 161 defining an interior space 153 of the chamber 121 through which liquid delivered to the chamber 121 flows from the inlet end 125 to the outlet end 127 thereof. The housing 151 suitably comprises an elongate tube 155 generally defining, at least in part, a sidewall 157 of the chamber 121. The tube 155 may have one or more inlet ports (three such inlet ports being illustrated in FIG. 1 and indicated at 156, 158, and 159) formed therein through which one or more liquids and/or gas isotopes to be treated within the chamber 151 are delivered to the interior space 153 thereof. It should be understood by one skilled in the art that the inlet end of the housing may include only one port or two ports (see FIGS. 2 and 3), and even more than three ports. For example, although not shown, the housing may comprise four inlet ports, wherein the first inlet port and the second inlet port are suitably in parallel, spaced relationship with each other, and the third inlet port and the fourth inlet port are suitably in parallel, spaced relationship with each other.

In one embodiment, the housing 151 may comprise a closure 163 connected to and substantially closing the longitudinally opposite end of the sidewall 157, and having at least one outlet port 165 therein to generally define the outlet end 127 of the treatment chamber 151. The sidewall 157 (e.g., defined by the elongate tube 155) of the chamber 151 has an inner surface 167 that together with the waveguide assembly (or waveguide assemblies described further below, and generally indicated at 201 and 203) and the closure 163 define the interior space 153 of the chamber. In the illustrated embodiment of FIG. 1, the tube 155 is generally cylindrical so that the chamber sidewall 157 is generally annular in cross-section. However, it is contemplated that the cross-section of the chamber sidewall 157 may be other than annular, such as polygonal or another suitable shape, and remains within the scope of this disclosure. The chamber sidewall 157 of the illustrated chamber 151 is suitably constructed of a transparent material, although it is understood that any suitable material may be used as long as the material is compatible with the liquid solutions being treated in the chamber, the pressure at which the chamber is intended to operate, and other environmental conditions within the chamber such as temperature.

A waveguide assembly, generally indicated at 203, extends longitudinally at least in part within the interior space 153 of the chamber 151 to ultrasonically energize the carrier liquid (and any other components of the carrier liquid) and the gas isotopes flowing through the interior space 153 of the chamber 151. In particular, the waveguide assembly 203 of the illustrated embodiment extends longitudinally from the lower or inlet end 125 of the chamber 121 up into the interior space 153 thereof to a terminal end 113 of the waveguide assembly disposed intermediate the inlet port (e.g., inlet port 158 where it is present). Although illustrated in FIG. 1 as extending longitudinally into the interior space 153 of the chamber 151, it should be understood by one skilled in the art that the waveguide assembly may extend laterally from a housing sidewall of the chamber, running horizontally through the interior space thereof without departing from the scope of the present disclosure. Typically, the waveguide assembly 203 is mounted, either directly or indirectly, to the chamber housing 161 as will be described later herein.

Still referring to FIG. 1, the waveguide assembly 203 suitably comprises an elongate horn assembly, generally indicated at 133, disposed entirely with the interior space 153 of the housing 161 intermediate the inlet port 158 and the outlet port 165 for complete submersion within the liquid being treated within the chamber 151, and more suitably, in the illustrated embodiment, it is aligned coaxially with the chamber sidewall 157. The horn assembly 133 has an outer surface 107 that together with the inner surface 167 of the sidewall 157 defines a flow path within the interior space 153 of the chamber 151 along which the carrier liquid and other components (e.g., gas isotopes to be fused) flow past the horn within the chamber (this portion of the flow path being broadly referred to herein as the ultrasonic treatment zone). The horn assembly 133 has an upper end defining a terminal end of the horn assembly (and therefore the terminal end 113 of the waveguide assembly) and a longitudinally opposite lower end 111. Although not shown, it is particularly preferable that the waveguide assembly 203 also comprises a booster coaxially aligned with and connected at an upper end thereof to the lower end 111 of the horn assembly 133. It is understood, however, that the waveguide assembly 203 may comprise only the horn assembly 133 and remain within the scope of this disclosure. It is also contemplated that the booster may be disposed entirely exterior of the chamber housing 161, with the horn assembly 133 mounted on the chamber housing 161 without departing from the scope of this disclosure.

The waveguide assembly 203, and more particularly the booster is suitably mounted on the chamber housing 161, e.g., on the tube 155 defining the chamber sidewall 157, at the upper end thereof by a mounting member (not shown) that is configured to vibrationally isolate the waveguide assembly (which vibrates ultrasonically during operation thereof) from the treatment chamber housing. Although the following description may apply to one or both waveguide assemblies independently, only the first waveguide assembly 203 will be described herein. That is, the mounting member inhibits the transfer of longitudinal and transverse mechanical vibration of the waveguide assembly 203 to the chamber housing 161 while maintaining the desired transverse position of the waveguide assembly (and in particular the horn assembly 133) within the interior space 153 of the chamber housing and allowing both longitudinal and transverse displacement of the horn assembly within the chamber housing. The mounting member also at least in part (e.g., along with the booster and/or lower end of the horn assembly) closes the inlet end 125 of the chamber 151. Examples of suitable mounting member configurations are illustrated and described in U.S. Pat. No. 6,676,003, the entire disclosure of which is incorporated herein by reference to the extent it is consistent herewith.

In one particularly suitable embodiment the mounting member is of single piece construction. Even more suitably the mounting member may be formed integrally with the booster (and more broadly with the waveguide assembly 203). However, it is understood that the mounting member may be constructed separately from the waveguide assembly 203 and remain within the scope of this disclosure. It is also understood that one or more components of the mounting member may be separately constructed and suitably connected or otherwise assembled together.

In one suitable embodiment, the mounting member is further constructed to be generally rigid (e.g., resistant to static displacement under load) so as to hold the waveguide assembly 203 in proper alignment within the interior space 153 of the chamber 151. For example, the rigid mounting member in one embodiment may be constructed of a non-elastomeric material, more suitably metal, and even more suitably the same metal from which the booster (and more broadly the waveguide assembly 203) is constructed. The term “rigid” is not, however, intended to mean that the mounting member is incapable of dynamic flexing and/or bending in response to ultrasonic vibration of the waveguide assembly 203. In other embodiments, the rigid mounting member may be constructed of an elastomeric material that is sufficiently resistant to static displacement under load but is otherwise capable of dynamic flexing and/or bending in response to ultrasonic vibration of the waveguide assembly 203.

A suitable ultrasonic drive system 131 including at least an exciter (not shown) and a power source (not shown) is disposed exterior of the chamber 151 and operatively connected to the booster (not shown) (and more broadly to the waveguide assembly 203) to energize the waveguide assembly to mechanically vibrate ultrasonically. Examples of suitable ultrasonic drive systems 131 include a Model 20A3000 system available from Dukane Ultrasonics of St. Charles, Ill., and a Model 2000CS system available from Herrmann Ultrasonics of Schaumberg, Ill.

In one embodiment, the drive system 131 is capable of operating the waveguide assembly 203 at a frequency in the range of about 15 kHz to about 100 kHz, more suitably in the range of about 15 kHz to about 60 kHz, and even more suitably in the range of about 20 kHz to about 40 kHz. Such ultrasonic drive systems 131 are well known to those skilled in the art and need not be further described herein.

In some embodiments, such as illustrated in FIG. 1, the treatment chamber can include more than one waveguide assembly having at least two horn assemblies for ultrasonically treating and electrolyzing liquid solutions. As noted above, the treatment chamber 151 comprises a housing 161 defining an interior space 153 of the chamber 151 through which the carrier liquid and gas isotopes are delivered from an inlet end 125. The housing 161 comprises an elongate tube 155 defining, at least in part, a sidewall 157 of the chamber 151. As illustrated, the tube 155 has three inlet ports 156, 158, and 159 formed therein, wherein the first inlet port 158 and third inlet port 156 are laterally opposed to the second inlet port 159, through which one or more carrier liquids and gas isotopes to be treated within the chamber 151 are delivered to the interior space 153 thereof, and at least one outlet port 165 through which the liquid, once treated, exits the chamber 151.

Two waveguide assemblies 201 and 203 extend longitudinally at least in part within the interior space 153 of the chamber 151 to ultrasonically energize the carrier liquid and gas isotopes flowing through the interior space 153 of the chamber 151. Each waveguide assembly 201 and 203 separately includes an elongate horn assembly, generally indicated at 135 and 133, respectively, each disposed entirely within the interior space 153 of the housing 161 intermediate the inlet ports 156, 158, and 159 and the outlet port 165 for complete submersion within the carrier liquid being treated within the chamber 151. Each horn assembly 133 and 135 can be independently constructed as described more fully above (including the horns 109 and 105, respectively, along with the plurality of agitating members 139 and 137 and baffle assemblies 249 and 245).

Although the following description may apply to one or both horn assemblies independently, only the first horn assembly will be described herein. The horn assembly 133 comprises an elongate, generally cylindrical horn 105 having an outer surface 107, and two or more (i.e., a plurality of) agitating members 137 connected to the horn and extending at least in part transversely outward from the outer surface of the horn in longitudinally spaced relationship with each other. The horn 105 is suitably sized to have a length equal to about one-half of the resonating wavelength (otherwise commonly referred to as one-half wavelength) of the horn. In one particular embodiment, the horn 105 is suitably configured to resonate in the ultrasonic frequency ranges recited previously, and most suitably at 20 kHz. For example, the horn 105 may be suitably constructed of a titanium alloy (e.g., Ti₆Al₄V) and sized to resonate at 20 kHz. The one-half wavelength horn 105 operating at such frequencies thus has a length (corresponding to a one-half wavelength) in the range of about 4 inches to about 6 inches, more suitably in the range of about 4.5 inches to about 5.5 inches, even more suitably in the range of about 5.0 inches to about 5.5 inches, and most suitably a length of about 5.25 inches (133.4 mm). It is understood, however, that the treatment chamber 151 may include a horn 105 sized to have any increment of one-half wavelength without departing from the scope of this disclosure.

In one embodiment (not shown), the agitating members 137 comprise a series of five washer-shaped rings that extend continuously about the circumference of the horn in longitudinally spaced relationship with each other and transversely outward from the outer surface of the horn. In this manner the vibrational displacement of each of the agitating members relative to the horn is relatively uniform about the circumference of the horn. It is understood, however, that the agitating members need not each be continuous about the circumference of the horn. For example, the agitating members may instead be in the form of spokes, blades, fins or other discrete structural members that extend transversely outward from the outer surface of the horn. For example, as illustrated in FIG. 1, one of the five agitating members are in a T-shape 701. Specifically, the T-shaped agitating member 701 surrounds the nodal region. It has been found that members in the T-shape, generate a strong radial (e.g., horizontal) acoustic wave that further increases the cavitation effect as described more fully herein.

By way of a dimensional example, the horn assembly 133 of the illustrated embodiment of FIG. 1 has a length of about 5.25 inches (133.4 mm), one of the rings 137 is suitably disposed adjacent the terminal end 113 of the horn 105 (and hence of the waveguide assembly 101), and more suitably is longitudinally spaced approximately 0.063 inches (1.6 mm) from the terminal end of the horn 105. In other embodiments the uppermost ring 137 may be disposed at the terminal end of the horn 105 and remain within the scope of this disclosure. The rings 137 are each about 0.125 inches (3.2 mm) in thickness and are longitudinally spaced from each other (between facing surfaces of the rings) a distance of about 0.875 inches (22.2 mm).

It is understood that the number of agitating members 137 (e.g., the rings in the illustrated embodiment) may be less than or more than five without departing from the scope of this disclosure. It is also understood that the longitudinal spacing between the agitating members 137 may be other than as illustrated in FIG. 1 and described above (e.g., either closer or spaced further apart). Furthermore, while the rings 137 illustrated in FIG. 1 are equally longitudinally spaced from each other, it is alternatively contemplated that where more than two agitating members are present the spacing between longitudinally consecutive agitating members need not be uniform to remain within the scope of this disclosure.

In particular, the locations of the agitating members 137 are at least in part a function of the intended vibratory displacement of the agitating members upon vibration of the horn assembly 133. For example, in the illustrated embodiment of FIG. 1, the horn assembly 133 has a nodal region located generally longitudinally centrally of the horn 105 (e.g., at the third ring). As used herein and more particularly shown in FIG. 1, the “nodal region” of the horn 105 refers to a longitudinal region or segment of the horn member along which little (or no) longitudinal displacement occurs during ultrasonic vibration of the horn and transverse (e.g., radial in the illustrated embodiment) displacement of the horn is generally maximized. Transverse displacement of the horn assembly 133 suitably comprises transverse expansion of the horn but may also include transverse movement (e.g., bending) of the horn.

In the illustrated embodiment of FIG. 1, the configuration of the one-half wavelength horn 105 is such that the nodal region is particularly defined by a nodal plane (i.e., a plane transverse to the horn member at which no longitudinal displacement occurs while transverse displacement is generally maximized) is present. This plane is also sometimes referred to as a “nodal point”. Accordingly, agitating members 137 (e.g., in the illustrated embodiment, the rings) that are disposed longitudinally further from the nodal region of the horn 105 will experience primarily longitudinal displacement while agitating members that are longitudinally nearer to the nodal region will experience an increased amount of transverse displacement and a decreased amount of longitudinal displacement relative to the longitudinally distal agitating members.

It is understood that the horn 105 may be configured so that the nodal region is other than centrally located longitudinally on the horn member without departing from the scope of this disclosure. It is also understood that one or more of the agitating members 137 may be longitudinally located on the horn so as to experience both longitudinal and transverse displacement relative to the horn upon ultrasonic vibration of the horn 105.

Still referring to FIG. 1, the agitating members 137 are sufficiently constructed (e.g., in material and/or dimension such as thickness and transverse length, which is the distance that the agitating member extends transversely outward from the outer surface 107 of the horn 105) to facilitate dynamic motion, and in particular dynamic flexing/bending of the agitating members in response to the ultrasonic vibration of the horn. In one particularly suitable embodiment, for a given ultrasonic frequency at which the waveguide assembly 203 is to be operated in the treatment chamber (otherwise referred to herein as the predetermined frequency of the waveguide assembly) and a particular liquid to be treated within the chamber 151, the agitating members 137 and horn 105 are suitably constructed and arranged to operate the agitating members in what is referred to herein as an ultrasonic cavitation mode at the predetermined frequency.

As used herein, the ultrasonic cavitation mode of the agitating members refers to the vibrational displacement of the agitating members sufficient to result in cavitation (i.e., the formation, growth, and implosive collapse of bubbles in a liquid) of the carrier liquid being treated at the predetermined ultrasonic frequency. For example, where the carrier liquid (and gas isotopes) flowing within the chamber comprises an aqueous liquid solution, and more particularly water, and the ultrasonic frequency at which the waveguide assembly 203 is to be operated (i.e., the predetermined frequency) is about 20 kHZ, one or more of the agitating members 137 are suitably constructed to provide a vibrational displacement of at least 1.75 mils (i.e., 0.00175 inches, or 0.044 mm) to establish a cavitation mode of the agitating members. Similarly, when using an organic carrier liquid, the ultrasonic frequency at which the waveguide assembly 203 is to be operated is about 20 kHz.

It is understood that the waveguide assembly 203 may be configured differently (e.g., in material, size, etc.) to achieve a desired cavitation mode associated with the particular carrier liquid and/or gas isotope to be treated. For example, as the viscosity of the liquid being treated changes, the cavitation mode of the agitating members may need to be changed.

In particularly suitable embodiments, the cavitation mode of the agitating members corresponds to a resonant mode of the agitating members whereby vibrational displacement of the agitating members is amplified relative to the displacement of the horn. However, it is understood that cavitation may occur without the agitating members operating in their resonant mode, or even at a vibrational displacement that is greater than the displacement of the horn, without departing from the scope of this disclosure.

In one suitable embodiment, a ratio of the transverse length of at least one and, more suitably, all of the agitating members to the thickness of the agitating member is in the range of about 2:1 to about 6:1. As another example, the rings each extend transversely outward from the outer surface 107 of the horn 105 a length of about 0.5 inches (12.7 mm) and the thickness of each ring is about 0.125 inches (3.2 mm), so that the ratio of transverse length to thickness of each ring is about 4:1. It is understood, however that the thickness and/or the transverse length of the agitating members may be other than that of the rings as described above without departing from the scope of this disclosure. Also, while the agitating members 137 (rings) may suitably each have the same transverse length and thickness, it is understood that the agitating members may have different thicknesses and/or transverse lengths.

In the above described embodiment, the transverse length of the agitating member also at least in part defines the size (and at least in part the direction) of the flow path along which the carrier liquid and gas isotopes or other flowable components in the interior space of the chamber flows past the horn. For example, the horn may have a radius of about 0.875 inches (22.2 mm) and the transverse length of each ring is, as discussed above, about 0.5 inches (12.7 mm). The radius of the inner surface of the housing sidewall is approximately 1.75 inches (44.5 mm) so that the transverse spacing between each ring and the inner surface of the housing sidewall is about 0.375 inches (9.5 mm). It is contemplated that the spacing between the horn outer surface and the inner surface of the chamber sidewall and/or between the agitating members and the inner surface of the chamber sidewall may be greater or less than described above without departing from the scope of this disclosure.

In general, the horn 105 may be constructed of a metal having suitable acoustical and mechanical properties. Examples of suitable metals for construction of the horn 105 include, without limitation, aluminum, monel, titanium, stainless steel, and some alloy steels. It is also contemplated that all or part of the horn 105 may be coated with another metal such as silver, platinum, gold, palladium, lead dioxide, and copper to mention a few. In one particularly suitable embodiment, the agitating members 137 are constructed of the same material as the horn 105, and are more suitably formed integrally with the horn. In other embodiments, one or more of the agitating members 137 may instead be formed separate from the horn 105 and connected thereto.

While the agitating members 137 (e.g., the rings) illustrated in FIG. 1 are relatively flat, i.e., relatively rectangular in cross-section, it is understood that the rings may have a cross-section that is other than rectangular without departing from the scope of this disclosure. The term “cross-section” is used in this instance to refer to a cross-section taken along one transverse direction (e.g., radially in the illustrated embodiment) relative to the horn outer surface 107). Additionally, although the agitating members 137 (e.g., the rings) illustrated in FIG. 1 are constructed only to have a transverse component, it is contemplated that one or more of the agitating members may have at least one longitudinal (e.g., axial) component to take advantage of transverse vibrational displacement of the horn (e.g., at and near the nodal region of the horn illustrated in FIG. 1) during ultrasonic vibration of the waveguide assembly 203.

As best illustrated in FIG. 1, the proximal end of the horn 105 is suitably spaced longitudinally from the inlet end 125 in FIG. 1 to define what is referred to herein as a liquid intake zone in which initial swirling of liquid within the interior space 153 of the chamber housing 161 occurs upstream of the horn 105. This intake zone is particularly useful where the treatment chamber 151 is used for mixing two or more components together (such as with the carrier liquid from inlet port 158 and the hydrogen gas isotopes from inlet port 156 in FIG. 1) whereby initial mixing is facilitated by the swirling action in the intake zone as the components to be mixed enter the chamber housing 161. It is understood, though, that the proximal end of the horn 105 may be nearer to the inlet end 125 than is illustrated in FIG. 1, and may be substantially adjacent to the inlet ports 156, 158 so as to generally omit the intake zone, without departing from the scope of this disclosure.

Additionally, a baffle assembly, generally indicated at 245 is disposed within the interior space 153 of the chamber 151, and in particular generally transversely adjacent the inner surface 167 of the sidewall 157 and in generally transversely opposed relationship with the horn 105. In one suitable embodiment, the baffle assembly 245 comprises one or more baffle members 247 disposed adjacent the inner surface 167 of the housing sidewall 157 and extending at least in part transversely inward from the inner surface of the sidewall toward the horn 105. More suitably, the one or more baffle members 247 extend transversely inward from the housing sidewall inner surface 167 to a position longitudinally intersticed with the agitating members 137 that extend outward from the outer surface 107 of the horn 105. The term “longitudinally intersticed” is used herein to mean that a longitudinal line drawn parallel to the longitudinal axis of the horn 105 passes through both the agitating members 137 and the baffle members 247. As one example, in the illustrated embodiment, the baffle assembly 245 comprises four, generally annular baffle members 247 (i.e., extending continuously about the horn 105) longitudinally intersticed with the five agitating members 237. Likewise, as illustrated in FIG. 1, a second baffle assembly 249 comprising one or more baffle members 251 extend transversely inward from the housing sidewall inner surface 167 to a position longitudinally intersticed with the agitating members 139 that extend outward from the outer surface 207 of the horn 109.

As a more particular example, the four annular baffle members 247 illustrated in FIG. 1 are of the same thickness as the agitating members 137 in our previous dimensional example (i.e., 0.125 inches (3.2 mm)) and are spaced longitudinally from each other (e.g., between opposed faces of consecutive baffle members) equal to the longitudinal spacing between the rings (i.e., 0.875 inches (22.2 mm)). Each of the annular baffle members 247 has a transverse length (e.g., inward of the inner surface 167 of the housing sidewall 157) of about 0.5 inches (12.7 mm) so that the innermost edges of the baffle members extend transversely inward beyond the outermost edges of the agitating members 137 (e.g., the rings). It is understood, however, that the baffle members 247 need not extend transversely inward beyond the outermost edges of the agitating members 137 of the horn 105 to remain within the scope of this disclosure.

It will be appreciated that the baffle members 247 thus extend into the flow path of the carrier liquid and gas isotopes that flow within the interior space 153 of the chamber 151 past the horn 105 (e.g., within the ultrasonic treatment zone). As such, the baffle members 247 inhibit the carrier liquid and gas isotopes from flowing along the inner surface 167 of the chamber sidewall 157 past the horn 105, and more suitably the baffle members facilitate the flow of the carrier liquid and gas isotopes transversely inward toward the horn for flowing over the agitating members of the horn to thereby facilitate ultrasonic energization (i.e., agitation) of the carrier liquid and gas isotopes to initiate thermonuclear fusion of the gas isotopes within the carrier liquid to form the treated liquid.

To inhibit gas bubbles against stagnating or otherwise building up along the inner surface 167 of the sidewall 157 and across the face on the underside of each baffle member 247, e.g., as a result of agitation of the carrier liquid, a series of notches (broadly openings) are formed in the outer edge of each of the baffle members (not shown) to facilitate the flow of gas (e.g., gas bubbles) between the outer edges of the baffle members and the inner surface of the chamber sidewall. For example, in one particularly preferred embodiment, four such notches are formed in the outer edge of each of the baffle members in equally spaced relationship with each other. It is understood that openings may be formed in the baffle members other than at the outer edges where the baffle members abut the housing, and remain within the scope of this disclosure. It is also understood, that these notches may number more or less than four, as discussed above, and may even be completely omitted.

It is further contemplated that the baffle members 247 need not be annular or otherwise extend continuously about the horn 105. For example, the baffle members 247 may extend discontinuously about the horn 105, such as in the form of spokes, bumps, segments or other discrete structural formations that extend transversely inward from adjacent the inner surface 167 of the housing sidewall 157. The term “continuously” in reference to the baffle members 247 extending continuously about the horn does not exclude a baffle members as being two or more arcuate segments arranged in end-to-end abutting relationship, i.e., as long as no significant gap is formed between such segments. Suitable baffle member configurations are disclosed in U.S. application Ser. No. 11/530,311 (filed Sep. 8, 2006), which is hereby incorporated by reference to the extent it is consistent herewith.

Also, while the baffle members 247 illustrated in FIG. 1 are each generally flat, e.g., having a generally thin rectangular cross-section, it is contemplated that one or more of the baffle members may each be other than generally flat or rectangular in cross-section to further facilitate the flow of gas bubbles along the interior space 153 of the chamber 151. The term “cross-section” is used in this instance to refer to a cross-section taken along one transverse direction (e.g., radially in the illustrated embodiment, relative to the horn outer surface 207).

The treatment chamber 151 is further connected to an electrical conducting generator, such as a DC current generator (indicated at 120), for creating an electrical potential within the interior space 153 of the chamber housing 161. It is believed that when initiating fusion between isotopes such as in the thermonuclear fusion of hydrogen gas isotopes, there is a disadvantage that arises from the fact that significantly high temperature and pressure conditions must be used to force the molecules to contact one another and fuse. Specifically, one of the main factors that control the rate of a fusion reaction under normal conditions is the rate at which the hydrogen isotope molecules dissolve within a liquid solution and come together. Typically, the solubility of the hydrogen gas isotopes in the carrier is limited and therefore limits the ability of having a thermonuclear fusion reaction between the gas isotopes. However, by electrically charging the treatment chamber as is intended in the present disclosure, this disadvantage can be overcome. Specifically, the application of the ultrasonic horn to also act as an electrode will enhance the concentration of the hydrogen gas isotopes in the vicinity of the ultrasonic horn from the charge attraction on the dipole moment of the gas isotopes and the electrical charge on the ultrasonic horn and thus increase the probability of having a successful thermonuclear fusion reaction. Additionally, when the horn is operating in the cavitation mode, microcurrents that are generated, as discussed above, will minimize and, more desirably, eliminate the hydrodynamic boundary layer around the electrode-like horn. Furthermore, the microcurrents will supply motion to the carrier liquid and gas isotopes, which can significantly enhance the overall fusion reactions between the gas isotopes that occur within the carrier liquid at the electrode.

As illustrated in FIG. 1, the generator 120 can be connected to the chamber 151 through electrical wires (indicated at 122 and 124) to one or more components of the treatment chamber 151. Specifically, in the illustrated embodiment, the generator 120 can be electrically connected to the outside surfaces 107 and 207 of horns 105 and 109, respectively, of the two horn assemblies 133 and 135 to create an electrode potential within the interior 153 of the housing 161 of the chamber 151. The outer surface 207 of the second horn 109 is electrically charged to behave as a cathode, while the outer surface 107 of the first horn 105 is electrically charged to behave as an anode (see FIG. 1 illustrating the terminal end of the first horn 105 as an anode and the terminal end of the second horn 109 as a cathode). It should be understood that the first horn 105 could alternatively act as the anode and the second horn 109 could act as the cathode without departing from the scope of this disclosure.

Typically, the electrode potential produced by the generator 120 of the present disclosure is in the range of from about 0.1V to about 24V. More suitably, the electrode potential is in the range of from about 0.5V to about 5.0V and, even more suitably, from about 1.3V to about 2.0V. Furthermore, typical current density produced by the electrode potential within the treatment chamber ranges from about 0.1 kA/m² to about 2 kA/m² and, more suitably, the current density can be from about 1 kA/m² to about 1.5 kA/m².

More specifically, the electrode potential will be determined and produced in an amount required for the desired purpose of treatment chamber. For example, where the treatment chamber is desired for use in fusing hydrogen gas isotopes in an aqueous carrier liquid, the electrode potential produced will be that which is necessary to enhance the concentration of the hydrogen gas isotopes in the vicinity of the respective electrodes (i.e., horns) through the dipole moment in the diatomic gas isotopes caused by charge attraction. Alternatively, where the treatment chamber is desired for use in fusing hydrogen gas isotopes in an organic carrier liquid (e.g., formamide, N-methylformamide, N,N-dimethylformamide, N-methylacetamide, 1,2-diaminoethane, dimethylsulphoxide, adiponitrile, and adiponitrile), the electrode potential produced will be that which is necessary to enhance the concentration of the hydrogen gas isotopes in the vicinity of the respective electrodes (i.e., horns) through the electrical attraction of the dipole moment in the diatomic gas isotopes and the ultrasonic horn. It should be understood by one skilled in the art that the examples described above should not be limiting as the electrode potential can be controlled over various ranges and for other additional uses, such as the mixing of liquid solutions and additional chemical reactions, without departing from the scope of this disclosure.

Moreover, it should be understood by one skilled in the art, that while the electrical wires can connect the generator to multiple waveguide assemblies, each being fully disposed within the interior of the chamber housing of a single treatment chamber, the generator can be connected to numerous other areas of the treatment chamber without departing from the scope of this disclosure. For example, in one embodiment, only one waveguide assembly is used within the treatment chamber and, in this embodiment, the electrical wires connect the generator to the waveguide assembly and to the sidewall of the chamber. Specifically, the generator charges the waveguide assembly as the cathode and the sidewall of the treatment chamber as an anode, and vice versa.

As there is an electrode potential produced within the interior 153 of the chamber housing 161 by connecting the first horn 105 and second horn 109 to a generator 120, it is desirable for the housing 161 to be electrically insulated from the waveguide assemblies 203, 201, respectively, to maintain the electrode-like effect. As such, in the illustrated embodiment, the housing sidewall 157 is separated from the first waveguide assembly 203 (and thus, the horn 105) by at least two insulating members 210 and 212 and from the second waveguide assembly 201 using at least two insulating members 214 and 216.

Typically, the insulating members 210, 212, 214, 216 can be made using any insulating material known in the art. For example, the insulating members 210, 212, 214, 216 may be produced using any one of a multitude of known inorganic or organic insulating materials. Particularly suitable materials that could be used for the insulating members 210, 212, 214, 216 include solid materials with a high dielectric strength, such as for example, glass, mylar, kapton, ceramic, phenolic glass/epoxy laminates, and the like.

In addition to the treatment chamber and its components described above, the thermonuclear fusion system further may include a heat exchanger (generally indicated in FIG. 1 at 300). The heat exchanger 300 is typically in direct fluid communication with the outlet port 165 of the treatment chamber 151. Specifically, treated liquid (not shown) exits the treatment chamber 151 from the outlet port 165 and is delivered to the heat exchanger 300, wherein thermal energy is extracted from the treated liquid in the form of steam. One particularly preferred type of heat exchanger is a tube and shell heat exchanger, such as is commercially available from Exergy, LLC (Garden City, N.Y.).

Once the steam is extracted from the treated liquid, the liquid, which is back in the form of the initial carrier liquid as described above, is pumped back into the thermonuclear fusion system to be reused.

In one embodiment, as illustrated in FIG. 1, one or more pressure valves 302 may be included in the thermonuclear fusion system in fluid communication with the heat exchanger 300 and feed pump 129 for pumping carrier liquid, once steam is removed from the treated liquid, into the treatment chamber 151.

A degasser may also be included in the thermonuclear fusion system. For example, as shown in FIG. 2, once carrier liquid is pumped from the heat exchanger 500, the carrier liquid is sparged with the hydrogen gas isotopes and flows into a degasser 560 in which excess gas bubbles are removed from the carrier liquid prior to the carrier liquid being pumped back into the treatment chamber 551 for re-use in fusing the gas isotopes. As the excess gas bubbles have been removed, there are substantially only dissolved hydrogen gas isotope molecules entering the treatment chamber 551. Therefore, the generation of the bubbles from the cavitation mode will be from the tensile rupture of the carrier liquid and not from the entrained excess gas bubble of the hydrogen gas isotope.

One particularly preferred degasser is a continuous flow gas-liquid cyclone separator, such as commercially available from NATCO (Houston, Tex.). It should be understood by a skilled artisan, however, that any other system that separates hydrogen gas isotopes from a carrier liquid by centrifugal action can suitably be used without departing from the present disclosure.

In operation according to one embodiment of the thermonuclear fusion system of the present disclosure, the fusion system (more specifically, the treatment chamber) is used to fuse hydrogen gas isotopes to create thermal energy. Specifically, a carrier liquid is delivered (e.g., by the pumps described above) via conduits to one or more inlet ports formed in the treatment chamber housing. The carrier liquid can be any suitable liquid known in the art for thermonuclear fusion. For example, in one particularly preferred embodiment, the carrier liquid is an aqueous liquid. Other suitable carrier liquids include organic liquids such as formamide, N-methylformamide, N,N-dimethylformamide, N-methylacetamide, 1,2-diaminoethane, dimethylsulphoxide, adiponitrile, adiponitrile, and the like. Still other suitable carrier liquids include molten salts and liquid metals.

Typically, the carrier liquid has a cooler temperature as compared to the treated liquid that is formed upon fusion of the gas isotopes mixed with the carrier liquid within the treatment chamber. For example, the carrier liquid suitably has a temperature when entering the treatment chamber (i.e., inlet temperature) of from about 1° C. (34° F.) to about 99° C. (210° F.). More suitably, the carrier liquid has an inlet temperature of from about 70° C. (158° F.) to about 98° C. (208° F.).

From about 1 liter per minute to about 100 liters per minute of the carrier liquid is typically delivered into the treatment chamber housing. More suitably, the amount of carrier liquid delivered into the treatment chamber housing is from about 2 liters per minute to about 50 liters per minute.

Additionally, a gas sparge, as described above, can be in fluid communication with the treatment chamber (through a third inlet port) to force gas isotopes (specifically, hydrogen gas isotopes) into the interior space of the chamber to mix with the carrier liquid. Typically, the hydrogen gas isotopes are pumped through an inlet port into the interior space at a rate of from about 0.001 liters per minute to about 10 liters per minute. More suitably, the hydrogen gas isotopes are pumped into the interior space at a rate of from about 0.01 liters per minute to about 5 liters per minute. As the carrier liquid and gas isotopes enter the interior space of the chamber via the inlet port, the orientation of the inlet ports can induce a relatively swirling action.

As described above in FIG. 2, the gas sparge may not directly force gas isotopes into an inlet port. Instead, the gas sparge forces gas into a degasser and then the carrier liquid (with excess gas removed) is delivered to a delivery system, which in turn, delivers the carrier liquid to the inlet end of the treatment chamber.

In another embodiment, as described above in FIG. 3, the gas sparge may be removed from the configuration and the gas isotopes may be created by electrolyzing heavy water. Specifically, the electrolysis of the heavy water will produce the hydrogen gas isotopes at the cathode horn along with oxygen at the anode horn within the treatment chamber. The hydrogen gas isotope will then be subjected to the cavitation mode generated by the ultrasonic horn to initiate the thermonuclear fusion of the hydrogen molecules.

In accordance with the above embodiment, as the carrier liquid and gas isotopes continue to flow upward within the chamber, the waveguide assembly, and more particularly the horn assembly, is driven by the drive system to vibrate at a predetermined ultrasonic frequency. In response to ultrasonic excitation of the horn, the agitating members that extend outward from the outer surface of the horn dynamically flex/bend relative to the horn, or displace transversely (depending on the longitudinal position of the agitating member relative to the nodal region of the horn).

The carrier liquid and gas isotopes continuously flow longitudinally along the flow path between the horn assembly and the inner surface of the housing sidewall so that the ultrasonic vibration and the dynamic motion of the agitating members causes cavitation in the carrier liquid to further facilitate agitation. The baffle members disrupt the longitudinal flow of liquid along the inner surface of the housing sidewall and repeatedly direct the flow transversely inward to flow over the vibrating agitating members.

Furthermore, the first waveguide assembly is electrically charged as an anode and the second waveguide assembly as a cathode. As such, as the carrier liquid and gas isotopes are pushed through the interior space of the chamber housing, the oppositely charged horns will each attract the diatomic hydrogen gas isotopes, thus increasing the dissolved concentration of the gas isotopes within the proximity of the horn. This increase in dissolved hydrogen gas concentration will increase the probably of obtaining successful thermonuclear fusion during the cavitation mode described herein.

In some embodiments, the diatomic property or dipole moment of the hydrogen gas isotopes can be increased for a better chance of fusion between the hydrogen gas isotopes. For example, when water is used as the carrier liquid, the carrier liquid itself has a relatively high dipole moment (e.g., water has a dipole moment of about 1.8 μ/D), however, by adding an acid to the aqueous liquid, the dipole moment may be increased. Suitable acids for use in the aqueous liquid can include, for example, hydrochloric acid, hydrofluoric acid, hydrobromic acid, and hydroiodic acid. The acid can be added to the aqueous liquid in any amount suitable to be effective to improve the dipole moment. It should be recognized by one skilled in that art, however, that the higher the acid concentration of the aqueous liquid, the higher the dipole moment.

Furthermore, as mentioned above, due to the cavitation produced, microbubbles of hydrogen gas within the carrier liquid are created. As these microbubbles then collapse, the pressure and temperature within the carrier liquid are both increased and the hydrogen gas isotopes are driven into each other, thereby fusing. Specifically, as the partial pressure of the hydrogen gas isotopes in the cavitation microbubbles increases, so will the concentration of the dissolved hydrogen gas isotopes in the carrier liquid. This phenomenon is captured in Henry's Law:

C_{gas}=P_{gas}/Kₕ

wherein: C_{gas} is the concentration of dissolved hydrogen gas isotopes within the carrier liquid; P_{gas} is the partial pressure of hydrogen gas above the carrier liquid (i.e., in the microbubble); and Kₕ is Henry's Law constant (which, for hydrogen is 1282.1 L*atm/mol).

Thus, during the collapse of the cavitation microbubbles, tremendous pressures are generated which will significantly increase the concentration of the dissolved hydrogen gas isotopes in the carrier liquid. And, with a greater concentration of dissolved hydrogen gas isotopes in the carrier liquid, it is believed that the greater the probability of two hydrogen gas isotopes fusing will be.

Once the hydrogen gas isotopes fuse within the carrier liquid, the thermonuclear fusion reaction forms a treated liquid. During the thermonuclear fusion reaction, the temperature within the housing may increase to a temperature range of from about 3,000° K (2,727° C.; 4,940° F.) to about 3,000,000° K (2,999,727° C.; 5,399,540° F.). Additionally, the pressure within the housing once the hydrogen gas isotopes fuse is from about 10 atmospheres (atm) to about 4,000 atm. More suitably, the temperature of the housing increases to a range of from about 5,000° K (4,727° C.; 8,540° F.) to about 1,000,000° K (999,727° C.; 1,799,540° F.), and the pressure increases to a range of from about 100 atm to about 2,000 atm.

Typically, the treated liquid has a sufficiently high temperature, thereby generating thermal energy in the form of steam. Specifically, the treated liquid has a temperature of at least 100° C. (212° F.) so as to create super heated water through the heat exchanger for the subsequent generation of steam. More suitably, the treated liquid has a temperature of from about 101° C. (213.8° F.) to about 170° C. (338° F.). In one embodiment, as depicted in FIG. 2, as the treated liquid has a temperature is excess of 100° C., the cold water return on the heat exchanger 500, generally indicated at 502, will generate steam at ambient pressures. This steam will subsequently rotate turbines (not shown) and generate electrical energy.

Once the steam is extracted from the treated liquid, the liquid, which is back in the form of the initial carrier liquid as described above, is pumped back into the thermonuclear fusion system to be reused.

When introducing elements of the present invention or preferred embodiments thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A thermonuclear fusion system for thermonuclear fusing hydrogen gas isotopes, the thermonuclear fusion system comprising:
a treatment chamber comprising:
an elongate housing having longitudinally opposite ends and an interior space, the housing being generally closed at at least one longitudinal end and having at least a first inlet port for receiving a carrier liquid and hydrogen gas isotopes into the interior space of the housing and at least one outlet port through which a treated liquid is exhausted from the housing following ultrasonic treatment of the carrier liquid and hydrogen gas isotopes to form the treated liquid, the outlet port being spaced longitudinally from the first inlet port such that the carrier liquid and hydrogen gas isotopes flow longitudinally within the interior space of the housing from the first inlet port to the outlet port;
a first elongate ultrasonic waveguide assembly extending longitudinally within the interior space of the housing and being operable at a first predetermined ultrasonic frequency to ultrasonically energize the carrier liquid and hydrogen gas isotopes flowing within the housing, the first waveguide assembly comprising a first elongate ultrasonic horn disposed at least in part intermediate the first inlet port and the outlet port of the housing and having an outer surface located for contact with the carrier liquid and hydrogen gas isotopes flowing within the housing from the first inlet port to the outlet port, and a plurality of discrete agitating members in contact with and extending transversely outward from the outer surface of the first horn intermediate the first inlet port and the outlet port in longitudinally spaced relationship with each other, the agitating members and the first horn being constructed and arranged for dynamic motion of the agitating members relative to the first horn upon ultrasonic vibration of the first horn at the first predetermined frequency and to operate in an ultrasonic cavitation mode of the agitating members corresponding to the first predetermined frequency and the carrier liquid and hydrogen gas isotopes being treated in the chamber;
a second elongate ultrasonic waveguide assembly extending longitudinally within the interior space of the housing and being oriented in parallel to the first elongate ultrasonic waveguide assembly, the second waveguide assembly being operable at a second predetermined ultrasonic frequency to ultrasonically energize the carrier liquid and hydrogen gas isotopes flowing within the housing and comprising a second elongate ultrasonic horn disposed at least in part intermediate the first inlet port and the outlet port of the housing and having an outer surface located for contact with the carrier liquid and hydrogen gas isotopes flowing within the housing from the first inlet port to the outlet port, and a plurality of discrete agitating members in contact with and extending transversely outward from the outer surface of the second horn intermediate the first inlet port and the outlet port in longitudinally spaced relationship with each other, the agitating members and the second horn being constructed and arranged for dynamic motion of the agitating members relative to the second horn upon ultrasonic vibration of the second horn at the second predetermined frequency and to operate in an ultrasonic cavitation mode of the agitating members corresponding to the second predetermined frequency and the carrier liquid and hydrogen gas isotopes being treated in the chamber;
an electrical current source being in electrical contact with the outer surface of the first horn and the outer surface of the second horn, thereby producing an electrode potential within the interior space of the housing; and
at least a first insulating member and a second insulating member electrically insulating the housing from the first waveguide assembly and at least a third insulating member and a fourth insulating member electrically insulating the housing from the second waveguide assembly.

2. The thermonuclear fusion system as set forth in claim 1 wherein the hydrogen gas isotopes are selected from the group consisting of deuterium hydrogen gas isotopes, tritium hydrogen gas isotopes, and combinations thereof.

3. The thermonuclear fusion system as set forth in claim 1 wherein the housing comprises a first inlet port, a second inlet port, and a third inlet port, wherein the first inlet port and second inlet port are located on opposing sides and are independently configured to receive the carrier liquid, and wherein the third inlet port is configured to receive hydrogen gas isotopes.

4. The thermonuclear fusion system as set forth in claim 3 further comprising a gas sparge for pumping the hydrogen gas isotopes into the third inlet port, wherein the hydrogen gas isotopes are pumped into the third inlet port at a rate of from about 0.001 liters per minute to about 10 liters per minute.

5. The thermonuclear fusion system as set forth in claim 1 wherein the carrier liquid is an aqueous liquid having an inlet temperature in the range of from about 1° C. to about 99° C.

6. The thermonuclear fusion system as set forth in claim 1 wherein the carrier liquid is an organic liquid selected from the group consisting of formamide, N-methylformamide, N,N-dimethylformamide, N-methylacetamide, 1,2-diaminoethane, dimethylsulphoxide, adiponitrile, and adiponitrile.

7. The thermonuclear fusion system as set forth in claim 1 wherein the temperature within the housing increases to a temperature range of from about 3,000° K to about 3,000,000° K upon the fusion of the hydrogen gas isotopes in the treatment chamber.

8. The thermonuclear fusion chamber as set forth in claim 1 wherein the pressure within the housing increases to a pressure range of from about 10 atmospheres to about 4,000 atmospheres upon the fusion of the hydrogen gas isotopes in the treatment chamber.

9. The thermonuclear fusion system as set forth in claim 1 wherein the electrode potential produced is in the range of from about 0.1V to about 24V.

10. The thermonuclear fusion system as set forth in claim 1 wherein the electrode potential electrically charges the first horn as an anode and the second horn as a cathode.

11. The thermonuclear fusion system as set forth in claim 1 wherein the first horn and agitating members together define a first horn assembly of the first waveguide assembly, the first horn assembly being disposed entirely within the interior space of the housing, and wherein the second horn and agitating members together define a second horn assembly of the second waveguide assembly, the second horn assembly being disposed entirely within the interior space of the housing.

12. The thermonuclear fusion system as set forth in claim 1 wherein at least one of the agitating members of the first waveguide assembly comprises a T-shape and at least one of the agitating members of the second waveguide assembly comprises a T-shape.

13. The thermonuclear fusion system as set forth in claim 1 wherein the treated liquid is an aqueous liquid having a temperature of at least 100° C.

14. The thermonuclear fusion system as set forth in claim 13 further comprising a heat exchanger in direct fluid communication with the outlet port.

15. The thermonuclear fusion system as set forth in claim 14 wherein the heat exchanger allows steam to be released from the treated liquid to form the carrier liquid to be recycled back to the treatment chamber.

16. The thermonuclear fusion system as set forth in claim 15 further comprising a degasser for removing gas from the carrier liquid prior to the carrier liquid being recycled back into the treatment chamber.

17. A method for generating hydrogen gas isotopes for use in the thermonuclear fusion system of claim 1, the method comprising:
delivering heavy water selected from the group consisting of deuterated heavy water and tritiated heavy water to the treatment chamber; and
electrolyzing the heavy water to generate hydrogen gas isotopes.

18. The method as set forth in claim 17 further comprising degassing the heavy water prior to delivering the heavy water to the treatment chamber.
